(19) United States
(12) Patent Application Publication
(10) Pub. No.: US 2026/0260222 A1
(43) Pub. Date: Sep. 3, 2026

(54) A SYSTEM FOR IDENTIFYING THE RELATIONSHIP BETWEEN USERS BY USING MOBILE NETWORK COMMUNICATION DATA

(71) Applicant: TURKCELL TEKNOLOJI ARASTIRMA VE GELISTIRME ANONIM SIRKETI, Istanbul (TR)

(72) Inventors: Semih AKTAS, Istanbul (TR); Buse BILGIN, Istanbul (TR)

(73) Assignee: TURKCELL TEKNOLOJI ARASTIRMA VE GELISTIRME ANONIM SIRKETI, Istanbul (TR)

(21) Appl. No.: 19/491,229

(22) PCT Filed: Dec. 28, 2023
(86) PCT No.: PCT/TR2023/051802

§ 371 Date: Dec. 8, 2025

(30) Foreign Application Priority Data
Oct. 2, 2023 (TR) 2023/012288

(51) Int. Cl. G06Q 10/42; H04L 67/50; H04L 67/52

(52) U.S. Cl. CPC G06Q 10/42; H04L 67/52; H04L 67/535

(57) ABSTRACT

The present invention relates to a system for identifying the relationship and/or intimacy between two users by means of an artificial intelligence model by acquiring the interactions between the said two users from miscellaneous data sources.

### TECHNICAL FIELD

The present invention relates to a system for identifying the relationship and/or intimacy between two users by means of an artificial intelligence model by acquiring the interactions between the said two users from miscellaneous data sources.

### BACKGROUND OF THE INVENTION

Mobile network infrastructures are planned and updated in order to maximize the communication efficiency of persons. Currently, a large amount of data is analyzed and difficulties are experienced in determining relationships via meaningful parts of data. Today, mobile network infrastructures lack the ability to model human m and communication needs during emergencies and disasters, the infrastructure remains incapable and decreases are observed in user experience.

Therefore, it is understood that there is need for a system which provides a smart support and modeling platform developed by analyzing historical communication data in order to improve the efficiency of infrastructure processes.

The Chinese patent document no. CN106570764, an application included in the state of the art, discloses a user relationship prediction method. The said invention discloses a user relationship prediction method. The method comprises the steps of extracting the track data of each mobile user and a predetermined target user in a predetermined time period; the track data includes the timestamp of the service of a user terminal and a base station identification code; the position similarity of each mobile user and the target user at a geographic position is calculated according to the track data; the social similarity of each mobile user and the target user in a social network is calculated; and according to the position similarity and the social similarity, a predetermined relational prediction model is used to predict the user relationship between each mobile user and the target user.

However, the chinese patent document no. CN106570764 fails to provide solutions in terms of analysis of dynamic location information and also movement information, analysis of periodically visited places in order to categorize user relationships; analyzing the relationship with the persons contacted and analyzing it together with other locations according to the level of relationship in addition to the current location; making a positioning-based classification; obtaining statistical information such as conversation and messaging periods, duration and routine-not limited to location and social media information; obtaining the modules included in the relationship prediction system, which include more complex and sensitive analyses such as the emotional state during the speech analyzed by voice and the speech theme derived from the speech and message content; and use of inputs and outputs of modules, data storage methods and artificial intelligence at different layers (location-based classification, classification of interaction type, sentiment analysis and content analysis) The Chinese patent document no. CN110731096A, an application included in the state of the art, focuses on developing a method of analyzing the degree of intimacy and proximity of persons who communicate by using the communication information obtained from a terminal. Call history, conversation duration, conversation period, text message history, frequency of keywords used in messages, address information and time of last conversation are used to perform the said analysis.

However, the Chinese patent document no. CN110731096A does not include details such as any analysis model, how to perform the analysis or how to use the said data; it performs all the analysis on the end device (e.g. mobile phone), aims to use the message content by using some keywords in the messages, and does not include details such as the targeted word group.

### SUMMARY OF THE INVENTION

An objective of the present invention is to realize a system which is developed in order to optimize significant performance indicators for operators such as service quality, user satisfaction and energy consumption by predicting periodic movements and then increasing the capacity in areas where it is needed or making the necessary updates where the capacity requirement will decrease.

Another objective of the present invention is to realize a system which is realized to maximize the user experience by predicting how people will move in extraordinary situations and shaping investments accordingly.

Another objective of the present invention is to realize a system which is developed to assist in the use of smart analysis in grid planning.

Another objective of the present invention is to realize a system which is developed to realize an innovative approach by integrating innovative methodologies (machine learning, deep learning) into the existing problem.

### DETAILED DESCRIPTION OF THE INVENTION

“A System for Identifying the Relationship Between Users by Using Mobile Network Communication Data” realized to fulfil the objective of the present invention is shown in the figure attached, in which:

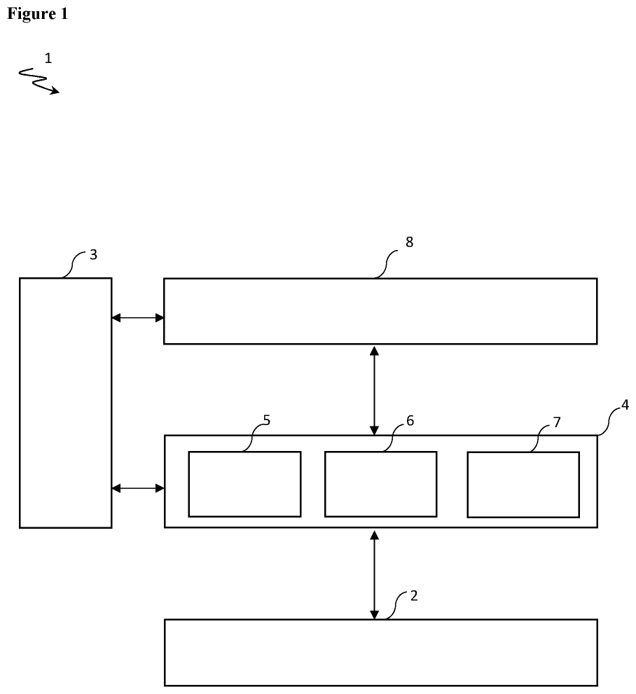

FIG. 1 is a schematic view of the inventive system.
1. System
2. Core Network Server
3. Database
4. Interaction Analysis Server
5. Location Analysis Server
6. Interaction-Type Analysis Server
7. Communication Analysis Server
8. Relationship Prediction Server
   A. User A
   B. User B

The inventive system (1) developed for identifying the relationship and/or intimacy between two users by means of an artificial intelligence model by acquiring the interactions between the said two users from miscellaneous data sources; comprises
at least one core network server (2) which is configured to retrieve interactions between users and to forward them to the analysis servers for analysis;
at least one database (3) which is configured to keep record of the users' registered locations and historical user locations and/or retrieve them from registered databases;
at least one interaction analysis server (4) which is configured to analyze interactions between two users according to interaction types and metadata;
at least one location analysis server (5) which is configured to analyze the location of users on vacation, at home, at school, at work, on the road, in the city, outside the city by performing coded classification upon processing the information received from the database (3) via neural networks;
at least one interaction-type analysis server (6) which is configured to evaluate instant interaction by processing information such as event type, event duration, event length and size; to analyze past events by perfoming examinations such as frequency of interactions, average duration, total number, monthly number, weekly number, daily number, number by type, division of events into time periods during the day; and to perform a classification developed via artificial intelligence neural networks by processing the interaction information together;
at least one communication analysis server (7) which is configured to systematically process voice and message contents; and
at least one relationship prediction server (8) which is configured to retrieve the outputs of the location analysis server (5), the interaction-type analysis server (6) and the communication analysis server (7); to miscellaneously define the relationship between two users across all classes of relationships between two persons such as friendship, business relationship, family, close family, unknown, intimate; and to enable service providers to make preparations in order to achieve minimum levels of service continuity.

The core network server (2) included in the inventive system (1) is configured to retrieve interactions between the User A (A) and the User B (B) and to transmit them to the analysis servers for analysis.

The database (3) included in the inventive system (1) is configured to store all interaction data of the users. The database (3) is configured to keep record of the users' registered locations, historical user locations and base station locations and/or to retrieve them from registered databases.

The interaction analysis server (4) included in the inventive system (1) is configured to retrieve interactions between the User A (A) and the User B (B). The interaction analysis server (4) is configured to extract user information from the interaction. The interaction analysis server (4) is configured to retrieve historical interactions between users contained in the database (3). The interaction analysis server (4) is configured to analyze the interactions between users by using a pattern recognition algorithm according to the frequency of interactions between users, the time interval between interactions, the total number of interactions and the type of interaction. The interaction analysis server (4) is configured to perform current activity analysis according to interaction duration, interaction length, interaction type, interaction size. The interaction analysis server (4) is configured to classify interactions between users according to current and historical pattern analysis.

The location analysis server (5) included in the inventive system (1) is configured to retrieve interactions between the User A (A) and the User B (B). The location analysis server (5) is configured to extract user information and information of base station where the users are connected to from the interaction. The location analysis server (5) is configured to retrieve the location information of the users from the database (3). The location analysis server (5) is configured to retrieve the connected base station location information. The location analysis server (5) is configured to store the user location information in the database (3). The location analytics server (5) is configured to retrieve historical user location information and the connected base station location information from the database (3). The location analysis server (5) is configured to predict the user location by using machine learning models. The location analysis server (5) is configured to classify user locations according to geographical locations. The location analytics server (5) is configured to process registered location, location at the time of the event and user mobility-based predictive information data together for each user.

The interaction-type analysis server (6) included in the inventive system (1) is configured to retrieve interactions between the User A (A) and the User B (B). The interaction-type analysis server (6) is configured to evaluate the instant interaction as output and then to rely on these outputs for analysis. The interaction-type analysis server (6) is configured to process information such as event type, event duration, event length and event size. The interaction-type analysis server (6) is configured to evaluate the instant interaction. The interaction-type analysis server (6) is configured to analyze past activities. The interaction-type analysis server (6) is configured to perform past activity analysis on data such as frequency of interactions, average duration, total number, monthly number, weekly number, daily number, number by type, number of interactions divided by time of day. The interaction-type analysis server (6) is configured to process the interaction information together and then to perform a classification enhanced by artificial intelligence neural networks.

The communication analysis server (7) included in the inventive system (1) is configured to retrieve interactions between the User A (A) and the User B (B). The communication analysis server (7) is configured to generate outputs in terms of emotion and context. The communication analysis server (7) is configured to retrieve voice communications such as calls, voice messages and the like from interactions realized between users. The communication analysis server (7) is configured to perform sentiment analysis of the received voice communications by using machine learning. The communication analysis server (7) is configured to classify the sentiments of voice communications as a result of the sentiment analysis thereof. The communication analysis server (7) is configured to convert the received voice communication data into text by using speech to text methods. The communication analysis server (7) is configured to convert personal voice and environmental sounds separately or together when converting received voice communication data into text by using speech to text methods. The communication analysis server (7) is configured to convert person speech included in audio into text together with ambient information by preserving the ambient sounds when converting from audio to text (Sound to Text Converter). The communication analysis server (7) is configured to convert the audio data to text and then to enable the converted text to be used as subtitles for videos. The communication analysis server (7) is configured to convert the content of the voice-to-text transcribed text into emotion by using natural language processing methods. The communication analysis server (7) is configured to retrieve past user interactions from the database (3) and to analyze the emotion in the current interaction by means of machine learning. The communication analysis server (7) is configured to retrieve past user interactions from the database (3) and to analyze the content included in the current interaction by means of machine learning. The communication analysis server (7) is configured to use Large Language Model (LLM) and Topic Modeling techniques when converting content from text.

The relationship prediction server (8) included in the inventive system (1) is configured to retrieve the outputs of location, activity and communication analyses as input. The relationship prediction server (8) is configured to retrieve the outputs of the location analysis (5), the interaction analysis (4) and the communication analysis (7) servers as inputs and to probabilistically identify the relationship between two users miscellaneously for all classes of relationships between two people such as friendship, business friendship, family, close family, unknown, intimate. The relationship prediction server (8) is configured to analyze interpersonal relationships by using mobile network communication data and to develop person-based solutions as a result of this analysis. The relationship prediction server (8) is configured to predict the periodic movements of users, to predict the movements of people in emergency and disaster situations and to obtain density and mobility data that can support infrastructure services and planning with an artificial intelligence-supported personalization infrastructure. The relationship prediction server (8) is configured to enable operators and service providers to prepare for emergency scenarios in the light of smart predictions and to make preparations to ensure minimum levels of service continuity.

### INDUSTRIAL APPLICABILITY OF THE INVENTION

The relationship prediction server (8) included in the inventive system (1) is configured to retrieve the outputs of location, interaction and communication analyses as input. The relationship prediction server (8) is configured to retrieve the outputs of the location, interaction and communication analysis servers as inputs and to probabilistically identify the relationship between two users miscellaneously for all classes of relationships between two people such as friendship, business friendship, family, close family, unknown, intimate. The relationship prediction server (8) is configured to analyze interpersonal relationships by using mobile network communication data and to develop person-based solutions as a result of this analysis. The relationship prediction server (8) is configured to predict the periodic movements of users, to predict the movements of people in emergency and disaster situations, and to obtain density and mobility data that can support infrastructure services and planning with an artificial intelligence-supported personalization infrastructure. The relationship prediction server (8) is configured to enable operators and service providers to prepare for emergency scenarios in the light of intelligent predictions and to make preparations to ensure minimum levels of service continuity. Thereby, it is ensured that interpersonal relationships are analysed by utilizing mobile network communication data, users' periodic movements are predecited by means of AI-supported individualization infrastructure, persons' movements are predicted in case of emergencies and disasters, density and mobility data that can support infrastructure services and planning are obtained and operators and service providers are enabled to make preparations to ensure service continuity to minimum levels by preparing for emergency scenarios in the light of intelligent predictions.

Within these basic concepts; it is possible to develop various embodiments of the inventive “System (1) for Identifying the Relationship Between Users by Using Mobile Network Communication Data”; the invention cannot be limited to examples disclosed herein and it is essentially according to claims.

1. A system (1) developed for identifying the relationship and/or intimacy between two users by means of an artificial intelligence model by acquiring the interactions between the said two users from miscellaneous data sources; comprising at least one core network server (2) which is configured to retrieve interactions between users and to forward them to the analysis servers for analysis;
at least one database (3) which is configured to keep record of the users' registered locations and historical user locations and/or retrieve them from registered databases;
and characterized by
at least one interaction analysis server (4) which is configured to analyze interactions between two users according to interaction types and metadata;
at least one location analysis server (5) which is configured to analyze the location of users on vacation, at home, at school, at work, on the road, in the city, outside the city by performing coded classification upon processing the information received from the database (3) via neural networks;
at least one interaction-type analysis server (6) which is configured to evaluate instant interaction by processing information such as event type, event duration, event length and size; to analyze past events by perfoming examinations such as frequency of interactions, average duration, total number, monthly number, weekly number, daily number, number by type, division of events into time periods during the day; and to perform a classification developed via artificial intelligence neural networks by processing the interaction information together;
at least one communication analysis server (7) which is configured to systematically process voice and message contents; and
at least one relationship prediction server (8) which is configured to retrieve the outputs of the location analysis server (5), the interaction-type analysis server (6) and the communication analysis server (7); to miscellaneously define the relationship between two users across all classes of relationships between two persons such as friendship, business relationship, family, close family, unknown, intimate; and to enable service providers to make preparations in order to achieve minimum levels of service continuity.

2. A system (1) according to claim 1; characterized by the core network server (2) which is configured to retrieve interactions between users and to forward them to the analysis servers (4, 5, 6, 7) for analysis.

3. A system (1) according to claim 1, characterized by the database (3) which is configured to store all interaction data of the users.

4. A system (1) according to claim 1, characterized by the database (3) which is configured to keep record of the users' registered locations, historical user locations and base station locations and/or to retrieve them from registered databases.

5. A system (1) according to claim 1, characterized by the interaction analysis server (4) which is configured to retrieve interactions between the User A (A) and the User B (B).

6. A system (1) according to claim 1, characterized by the interaction analysis server (4) which is configured to extract user information from the interaction.

7. A system (1) according to claim 1, characterized by the interaction analysis server (4) which is configured to retrieve historical interactions between users contained in the database (3).

8. A system (1) according to claim 1, characterized by the interaction analysis server (4) which is configured to analyze the interactions between users by using a pattern recognition algorithm according to the frequency of interactions between users, the time interval between interactions, the total number of interactions and the type of interaction.

9. A system (1) according to claim 1, characterized by the interaction analysis server (4) which is configured to perform current activity analysis according to interaction duration, interaction length, interaction type, interaction size.

10. A system (1) according to claim 1, characterized by the interaction analysis server (4) which is configured to classify interactions between users according to current and historical pattern analysis.

11. A system (1) according to claim 1, characterized by the location analysis server (5) which is configured to retrieve interactions between the User A (A) and the User B (B).

12. A system (1) according to claim 1, characterized by the location analysis server (5) which is configured to extract user information and information of base station where the users are connected to from the interaction.

13. A system (1) according to claim 1, characterized by the location analysis server (5) which is configured to retrieve the location information of the users from the database (3).

14. A system (1) according to claim 1, characterized by the location analysis server (5) which is configured to retrieve the connected base station location information.

15. A system (1) according to claim 1, characterized by the location analysis server (5) which is configured to store the user location information in the database (3).

16. A system (1) according to claim 1, characterized by the location analysis server (5) which is configured to retrieve historical user location information and the connected base station location information from the database (3).

17. A system (1) according to claim 1, characterized by the location analysis server (5) which is configured to predict the user location by using machine learning models.

18. A system (1) according to claim 1, characterized by the location analysis server (5) which is configured to classify user locations according to geographical locations.

19. A system (1) according to claim 1, characterized by the location analysis server (5) which is configured to process registered location, location at the time of the event and user mobility-based predictive information data together for each user.

20. A system (1) according to claim 1, characterized by the interaction-type analysis server (6) which is configured to retrieve interactions between the User A (A) and the User B (B).

21. A system (1) according to claim 1, characterized by the interaction-type analysis server (6) which is configured to evaluate the instant interaction as output and then to rely on these outputs for analysis.

22. A system (1) according to claim 1, characterized by the interaction-type analysis server (6) which is configured to process information such as event type, event duration, event length and event size.

23. A system (1) according to claim 1, characterized by the interaction-type analysis server (6) which is configured to evaluate the instant interaction.

24. A system (1) according to claim 1, characterized by the interaction-type analysis server (6) which is configured to analyze past activities.

25. A system (1) according to claim 1, characterized by the interaction-type analysis server (6) which is configured to perform past activity analysis on data such as frequency of interactions, average duration, total number, monthly number, weekly number, daily number, number by type, number of interactions divided by time of day.

26. A system (1) according to claim 1, characterized by the interaction-type analysis server (6) which is configured to process the interaction information together and then to perform a classification enhanced by artificial intelligence neural networks.

27. A system (1) according to claim 1, characterized by the communication analysis server (7) which is configured to retrieve interactions between the User A (A) and the User B (B).

28. A system (1) according to claim 1, characterized by the communication analysis server (7) which is configured to generate outputs in terms of emotion and context.

29. A system (1) according to claim 1, characterized by the communication analysis server (7) which is configured to retrieve voice communications such as calls, voice messages and the like from interactions realized between users.

30. A system (1) according to claim 1, characterized by the communication analysis server (7) which is configured to perform sentiment analysis of the received voice communications by using machine learning.

31. A system (1) according to claim 1, characterized by the communication analysis server (7) which is configured to classify the sentiments of voice communications as a result of the sentiment analysis thereof.

32. A system (1) according to claim 1, characterized by the communication analysis server (7) which is configured to convert the received voice communication data into text by using speech to text methods.

33. A system (1) according to claim 1, characterized by the communication analysis server (7) which is configured to convert personal voice and environmental sounds separately or together when converting received voice communication data into text by using speech to text methods.

34. A system (1) according to claim 1. characterized by the communication analysis server (7) which is configured to convert person speech included in audio into text together with ambient information by preserving the ambient sounds when converting from audio to text.

35. A system (1) according to claim 1, characterized by the communication analysis server (7) which is configured to convert the audio data to text and then to enable the converted text to be used as subtitles for videos.

36. A system (1) according to claim 1, characterized by the communication analysis server (7) which is configured to convert the content of the voice-to-text transcribed text into emotion by using natural language processing methods.

37. A system (1) according to claim 1, characterized by the communication analysis server (7) which is configured to retrieve past user interactions from the database (3) and to analyze the emotion in the current interaction by means of machine learning.

38. A system (1) according to claim 1, characterized by the communication analysis server (7) which is configured to retrieve past user interactions from the database (3) and to analyze the content included in the current interaction by means of machine learning.

39. A system (1) according to claim 1, characterized by the communication analysis server (7) which is configured to use Large Language Models and Topic Modeling techniques when converting content from text.

40. A system (1) according to claim 1, characterized by the relationship prediction server (8) which is configured to retrieve the outputs of location, activity and communication analyses as input.

41. A system (1) according to claim 1, characterized by the relationship prediction server (8) which is configured to retrieve the outputs of the location analysis (5), the interaction analysis (4) and the communication analysis (7) servers as inputs and to probabilistically identify the relationship between two users miscellaneously for all classes of relationships between two people such as friendship, business friendship, family, close family, unknown, intimate.

42. A system (1) according to claim 1, characterized by the relationship prediction server (8) which is configured to analyze interpersonal relationships by using mobile network communication data and to develop person-based solutions as a result of this analysis.

43. A system (1) according to claim 1, characterized by the relationship prediction server (8) which is configured to predict the periodic movements of users, to predict the movements of people in emergency and disaster situations and to obtain density and mobility data that can support infrastructure services and planning with an artificial intelligence-supported personalization infrastructure.

44. A system (1) according to claim 1, characterized by the relationship prediction server (8) which is configured to enable operators and service providers to prepare for emergency scenarios in the light of smart predictions and to make preparations to ensure minimum levels of service continuity.
